(19) United States
(12) Patent Application Publication
(10) Pub. No.: US 2003/0062734 A1
(43) Pub. Date: Apr. 3, 2003

(54) Device and method for handling fragile objects, and manufacturing method thereof

(76) Inventor: Sadeg M. Faris, Pleasantville, NY (US)

Correspondence Address: Ralph J. Crispino, Reveo, Inc., 85 Executive Blvd., Elmsford, NY, 10523, US

(21) Appl. No.: 10/017,186

(22) Filed: Dec. 7, 2001

Related U.S. Application Data
(60) Provisional application No. 60/326,432, filed on Oct. 2, 2001.

(51) Int. Cl. A47J 45/00

(52) U.S. Cl. 294/64.1

(57) ABSTRACT

A handler for applying a vacuum holding force to an object is provided. The handler generally includes a body having a plurality of levels of openings including a holding surface level and a suction surface level, and optionally one or more intermediate levels. In general, the openings decrease in size (e.g., effective diameter) from the suction surface level to the holding surface level. Further the openings at the suction surface level are in fluid communication with at least a portion of the openings at the holding surface level.

### RELATED APPLICATIONS

This application claims priority to U.S. Provisional Application Ser. No. 60/326,432, filed Oct. 2, 2001 entitled “Device and Method for Handling Fragile Objects, and Manufacturing Method Thereof”.

### BACKGROUND OF THE INVENTION

1. Field Of The Invention

The present invention relates to a device for and a method of handling a fragile object such as a thin film. More particularly, the disclosed device and method uses vacuum suction to support thin films, and is also suitable for use as a supporting substrate in manufacturing processes.

2. Description Of The Prior Art

The leading edge of technology in many fields is heading toward ever smaller dimensions. This is especially true for semiconductor based technologies, and in particular for the manufacturing of semiconductor devices themselves. Miniaturization, as the trend toward smaller sizes is called, is the key to enhance performance, increase reliability, and to reduce material and labor costs. Semiconductor technology, such as transistors, integrated circuits, chips, photonic devices, micro-electromechanical systems (MEMS) etc., permeate many other fields of science and technology, for instance biology, with the semiconductor technology facilitating capabilities and speed.

A key part of miniaturization involves thin films processing and handling. For instance, Silicon on Insulator, (SOI) technology is essentially a thin film endeavor. In SOI, and in many other technologies such as photovoltaics, for instance, bulky substrates are generally unnecessary. Essentially, substrates are provided for mechanical and thermal support of a very thin layer of material of interest at the surface of the substrate. As horizontal dimensions of devices shrink, presently approaching 100 nanometers at production scale, and tens of nanometers at the laboratory scale, the thickness of the structures also shrink. Thus, technology is progressing toward ever shallower device objects, or, in thin film terms, toward ever thinner films. Typical semiconductor technology based thin film today has a thickness which is in the order of about 50 micrometers to about 100 nanometers. In the near future one can expect the need to arise for handling films of 10 nanometers in thickness, or maybe even below this value. The frailty of such structures dictates a need for a reliable and delicate handler.

Thin films are also used in building up three dimensional structures, such as memory cubes, for instance. One such three dimensional system is described in U.S. Pat. No. 5,786,629 entitled “3-D Packaging Using Massive Fillo-Leaf Technology” by Sadeg. M. Faris, which is incorporated herein by reference.

If substrates are costly, and their role is limited essentially to supporting structures for very thin layers on their surfaces, a critical technological goal would be achieved by providing a capability for handling such fragile objects as thin films, and eliminating the need for bulky and unnecessary substrates. If thin films could be handled without the permanent attachment of the films to substrates, this would not only save the cost of the substrates, but would open up new avenues for processing, and allow for mass fabrication of thin films. However, the technical difficulties in such an endeavor are formidable. The films of interest are typically extremely thin and of large diameter. This is the situation in semiconductor manufacturing. Cost considerations drive larger diameter substrates, or wafers. Today the standard is a 200 mm wafer, but pilot work is progressing on 300 mm wafers. The thin films associated with semiconductor technology by default are of the same size. The critical question is how does one handle a film which may be 200 mm in diameter, or greater, but on the order of several microns in thickness.

Further, it is desirable to allow processing steps to be carried out on thin films while the thin film is supported by the handler. In other technologies, such as in biological sciences, one often faces the need to deal with fragile entities, such as those formed by aggregations, that are in need of strong but gentle mechanical support and thermal stability.

There have been some previous attempts to deal with handling of wafers. For instance, U.S. Pat. No. 6,257,564 to Avneri et al. (the '564 patent) teaches the gentle handling of wafers facilitated by use of support nipples and vacuum nipples. However, while such a structure may be useful for handling of wafers, processing of a wafer supported on the structure of the '564 patent is not conducive to processing on a handled wafer. In another example, U. S. Pat. No. 5,534,073 to Kinoshita et al. (the '073 patent) teaches a structure for handling of wafers even when they are “dirty”. However, a structure of the '073 patent requires at least pair of vacuum pumps.

### SUMMARY OF THE INVENTION

The above-discussed and other problems and deficiencies of the prior art are overcome or alleviated by the several methods and apparatus of the present invention for handling a fragile object. A handler is disclosed for applying a vacuum holding force to an object. The handler has very small diameter holes, which are suitable to hold very fragile objects utilizing vacuum suction, while also having sufficient thickness to minimize or eliminate warping or breakage. The vacuum paths within the handler for transferring suction force are configured to reduce the resistance thereof, thus minimizing the energy required to impart the requisite suction force, and further increasing the speed of connecting and disconnecting objects.

The handler includes a body having a plurality of levels of openings including a holding surface level and a suction surface level. In general, the openings at the suction surface level are larger than the openings at the holding surface level, and further the openings at the suction surface level are in fluid communication with at least a portion of the openings at the holding surface level. In certain embodiments, the frequency of the openings at the holding surface level is greater than the frequency of the openings at the suction surface level. Further, in certain embodiments at least a portion of the openings at the suction surface level that are in fluid communication with at least a portion of the openings at the holding surface level are in direct fluid communication by alignment of the openings, and interconnecting openings are provided for interconnecting openings at the holding surface level that are not in direct fluid communication by alignment of the openings.

In further embodiments, the handler further includes at least one intermediate level between the holding surface level and the suction surface level. The openings of the intermediate level are larger than the openings at the holding surface level and smaller that the openings at the suction surface level. The frequency of the openings at the intermediate level is generally greater than the frequency of the openings at the suction surface level. Also, at least a portion of the openings at the suction surface level that are in fluid communication with at least a portion of the openings at the intermediate level may be in direct fluid communication by alignment of the openings, and at least a portion of the openings at the intermediate level that are in fluid communication with at least a portion of the openings at the holding surface level may in direct fluid communication by alignment of the openings, wherein the handler further includes interconnecting openings for interconnecting openings at the intermediate level and at the holding surface level that are not in direct fluid communication by alignment of the openings.

In still further embodiments, the handler may includes at least one micro-valve in at least one of the openings.

Methods of making the handler include, but are not limited to, micro-machining the openings at each level, stacking patterned layers to form the openings at each level, or a combination thereof.

Therefore, in operation, the aforementioned handler has the capability to serve as a temporary substrate during processing of, for example, thin films. When the handler is formed of materials compatible with the intended processes, it may be subjected to the processing conditions, which in many circumstances is very harsh. After processing of the object, it is disconnected, and the handler may be reused for processing another object.

The above-discussed and other features and advantages of the present invention will be appreciated and understood by those skilled in the art from the following detailed description and drawings.

### BRIEF DESCRIPTION OF THE DRAWINGS

FIG. 1A is a schematic view of a system including a handler in relation to an object to be handled and a vacuum source;

FIG. 1B is a sectional view of a system including a handler in relation to an object to be handled and a vacuum source;

FIG. 2 is a sectional view of a handler according to one embodiment;

FIGS. 3A and 3B are topographical views of the handler of FIG. 2 at levels n and n+1, respectively;

FIG. 4 is a sectional view of a handler according to another embodiment;

FIG. 5 is a sectional view of a handler according to still anther embodiment;

FIG. 6 is a sectional view of a handler according to yet another embodiment;

FIG. 7 is a sectional view of a handler according to a further embodiment;

FIG. 8 is a sectional view of a handler according to still a further embodiment;

FIGS. 9A-9D depict an embodiment of a method of fabricating a handler;

FIGS. 10A-10B depict one example of a handler including micro-valves; and

FIGS. 11A-11B depict another example of a handler including micro-valves.

### DETAILED DESCRIPTION OF THE ILLUSTRATIVE EMBODIMENTS

A handler is provided for a fragile object that possesses sufficient rigidity and strength to withstand potentially rough mechanical handling, and also capable of serving as a substrate in typical semiconductor processing environment, for instance such as a photolithography, or a plasma processing environment. A suction force, or vacuum, may be transmitted from one side of the handler having one or more back surfaces capable of being attached to a vacuum device, to an opposing side where the fragile object can be received at a front surface, wherein the fragile object is subjected to the suction force via a plurality of apertures. The disclosed handler is capable of subjecting objects of extreme fragility to the suction force.

One of the primary considerations is the size and number of holes on the front surface of the handler. Due to the fragility of the films, and the nature and strength of the suction force, the holes on the front surface preferably have an effective diameter approximately equivalent to the thickness of the film to be handled. While larger holes may be easier to evacuate, and thus one would prefer as large diameter holes on the front surface as possible, the fragility of the thin object favors minimization of hole sizes. The result is the balance of utilizing holes with diameters approximately equaling the thickness of the thin fragile object. For example, a film having a thickness of about 100 nanometers should be pressed against the surface of a handler having holes of roughly 100 nanometers in diameter. Larger sized holes increase the risk of cracking the portions of the film over the hole. The other two dimensions of the film, and consequently those of the handler, can be expected to be of the order of over 100 millimeters, and as mentioned in the near future one can expect routine dealings with 300 millimeter diameter films. For the discussed embodiment the diameters of holes breaking the front surface are roughly a million times smaller than the diameter of the film, and that of the handler. Since the handler has to be mechanically strong, and rigid, to avoid bending itself, a typical distance from its front surface to its back surface may be at least about 1/10^{th} of the overall diameter of the handler, preferably at least about 1/50^{th} of the overall diameter of the handler, and more preferably at least about 1/100^{th} of the overall diameter of the handler.

Considering the example where the handler is about 100 millimeters in diameter, in a more preferred embodiment the handler thickness is in the order of a millimeter. Consequently, for similar reasons of mechanical integrity, the thickness of a semiconductor wafer, for instance silicon (Si), is also about one millimeter.

Accordingly, this a typical vacuum would have to be transmitted over a path of at least millimeter in length within 100 nanometer diameter holes. The length of such a hole would be over 10,000 times its diameter. Such a ratio is not practical, since air, or any other gas which may be used, would take an unacceptably long time to evacuate the holes. For instance, at some temperatures and pressures, and for some gases, the mean free path of the gas molecules would reach the hole diameter, thus a gas flow rate would be irrelevant.

As described herein, the solution to the gas flow problems associated with utilizing desirably small holes at an attraction surface of a handler is that one starts with small holes at the attraction surface, and appropriately stack larger holes in fluid communication with the small holes at the attraction surface, thereby increasing by order of magnitudes the gas flow rate from the front attraction surface to the back vacuum source surface.

Gas dynamics teaches that gas flow is approximately similar in holes where the hole cross section times the hole length is the same. For instance, if a first hole is twice the diameter of a second hole, then the two will have the approximately the same type of gas-dynamic flow if the first hole is four times as long as the second hole. In various preferred embodiments described herein, this principle will roughly be followed. While it is preferable to keep the smaller diameter holes as short as possible to improve evacuation rates, strength considerations limit the diameter ratios of holes that can be stacked on top of one another. In general, a hole diameter is preferably not much larger than the thickness of the layer having that hole. The holes described herein, while oftentimes referred to as cylindrically shaped, may be square or any other irregular shape, including a tapered shape. However, in any of such cases, one can always reasonably define and effective diameter, giving an effective cross section for use in estimations. Also, independently of the details of their shape, each hole has a length, and a top end pointing toward the back surface of the rigid body and a bottom end pointing toward the front surface of the rigid body.

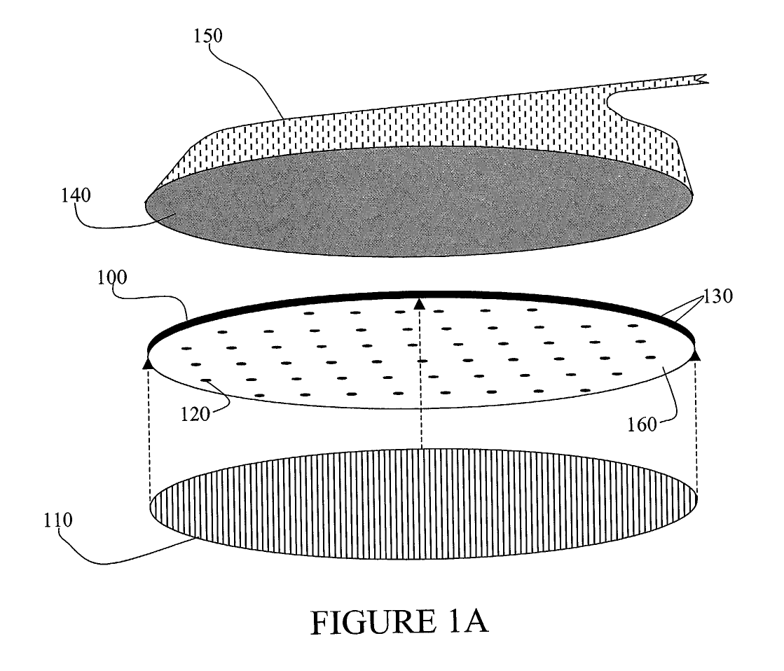

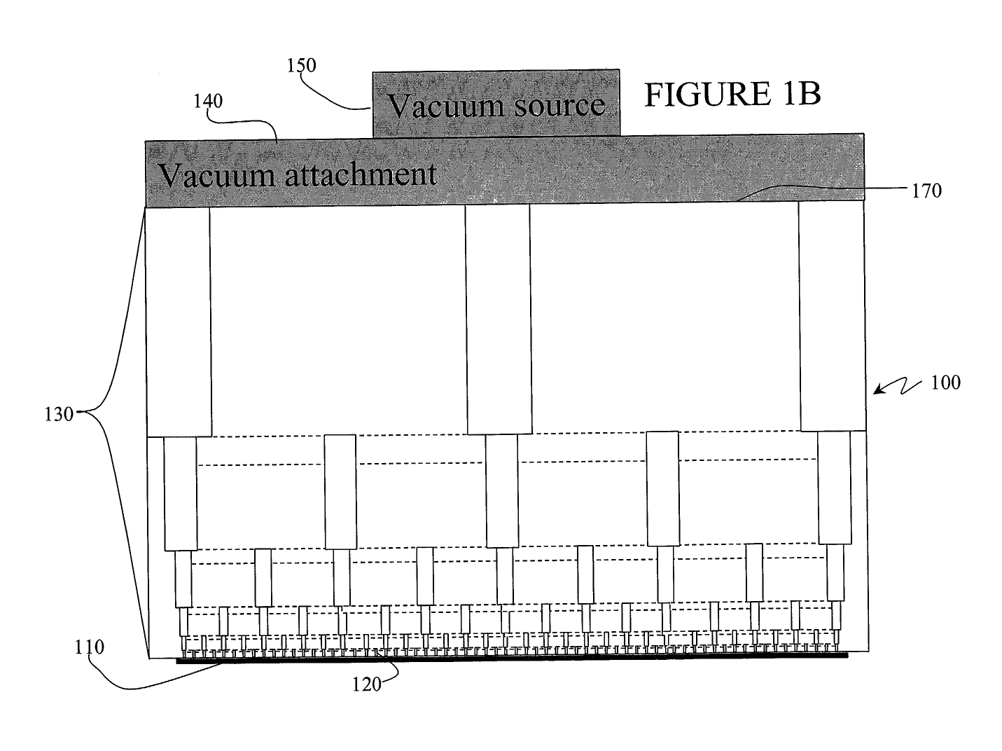

FIGS. 1A and 1B schematically depict a system including an embodiment of a handler 100 in relation to an object 110 to be handled and a vacuum source 140. The view of FIG. 1A is such that each object is seen from below, and FIG. 1B provides a sectional view. The fragile object 110 is a thin film, shown in corresponding relationship with the handler 100 with dotted arrows (FIG. 1A). In this embodiment the handler device 100 is disk shaped generally for handling disk shaped objects.

The handler device 100 includes a front surface 160 (FIG. 1A) and a back surface 170 (FIG. 1B). The surfaces are substantially parallel with one another, giving a defined thickness 130 to the handler device 100. The front surface 160 shows the bottom end of the bottommost holes 120 breaking the surface 160 in a regular pattern. These holes are at the end of chains of holes connecting the front surface with the back surface, and thereby forming low air resistance vacuum passages for a well distributed suction force to be applied to the object 110 (i.e., for handling). The back surface 170 is adapted to be attached to the vacuum source 150 via an attachment 140. Such an attachment can be accomplished in many ways which would be obvious to one of skill in the art. As illustrate in FIG. 1B, the handler 100 and the object 110 may be transported and handled as a single unit when a suction force is maintained (either by maintenance of the external vacuum, or closure of the openings on the back surface 170 after the object 110 has been removeably attached to the handler 100 to maintain the suction force). This greatly facilitates processing of the object 110. Further, subsequent to processing, the object 110 may be readily released from the handler 100, simply by removing all or a portion of the suction force.

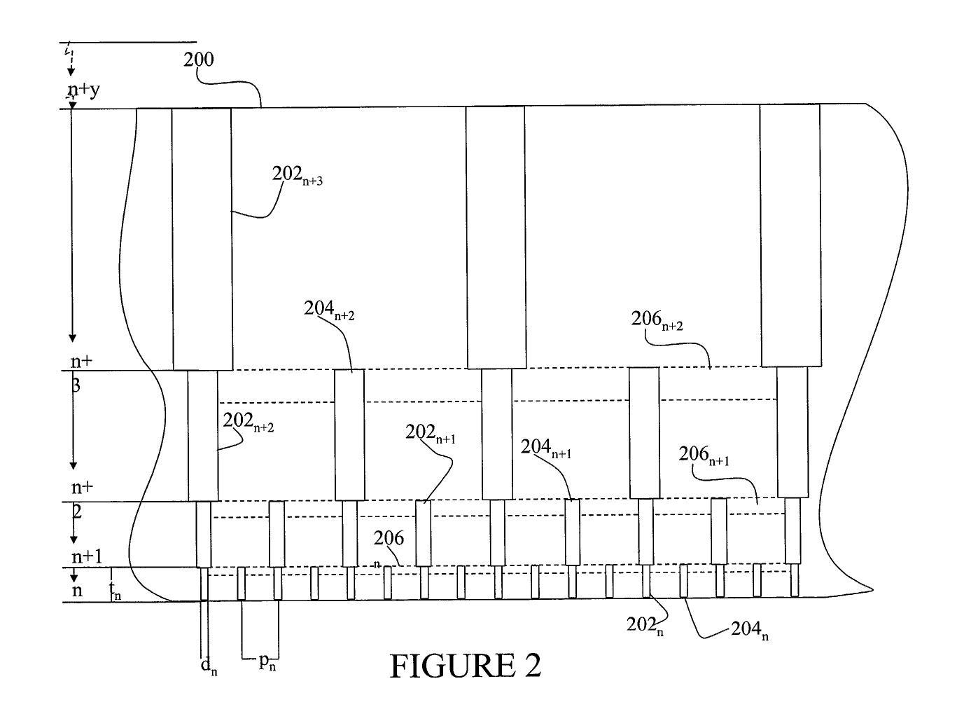

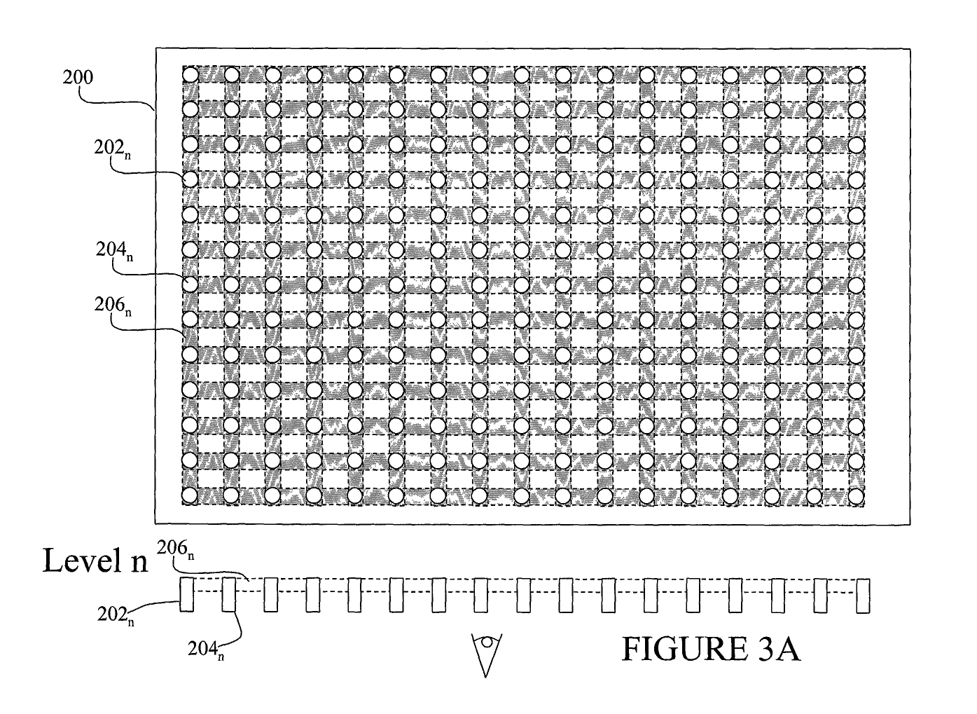

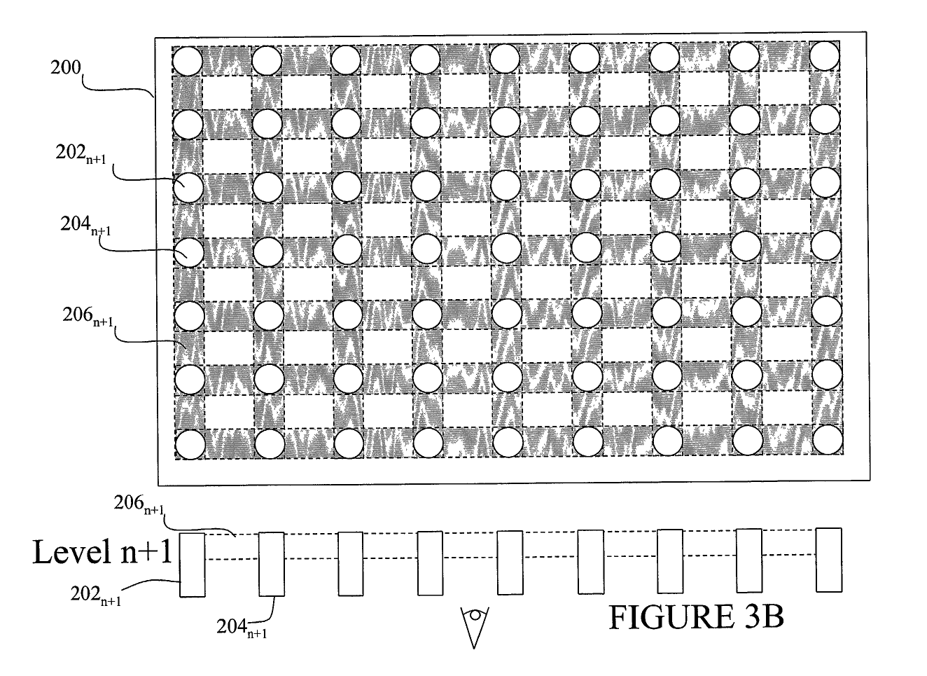

Referring to FIG. 2, a cross-sectional view of a handler 200 is provided, respectively. Also, referring to FIGS. 3A and 3B, individual levels of the handler 200 are depicted. As indicated, the handler 200 includes a plurality of levels n, n+1, . . . n+x, wherein n+x is any required number of levels depending on various factors. In FIG. 2, the handler 200 includes 4 levels: n=1; n+1=2; n+2=3; and n+3=4. On each level, the openings are indicated as openings 202ₙ, for openings aligned with openings 202ₙ₊₁, thereabove (as oriented in the Figure) and 204ₙ, for openings not aligned with openings 202ₙ₊₁, thereabove (as oriented in the Figure). The openings 204ₙ₊ₓ, wherein x is between 0 and 2 as shown in the Figures, are in fluid communication with each other and the openings 202ₙ₊ₓ, via horizontal (as oriented in FIG. 2) channels 206ₙ₊ₓ. Note that y is described in this embodiment as reaching the second to the top level, since the top level is in fluid communication with the vacuum source (directly or via one or more attachments).

The handler 200 is defined by several parameters. The number of levels n+x, as indicated above, is any required number of levels depending on various factors. Each level is characterized by a thickness tₙ, a hole diameter dₙ, and a period, or distance between holes, pₙ. In general, to balance the mechanical integrity and the holding force, i.e., the airflow, of the handler 200, the ratio dₙ/pₙ is less than 1. In certain embodiments, the ratio dₙ/pₙ is less than 0.5, 0.25, or lower, depending on the required holding force.

Further, to generally maintain airflow velocities in each level that are as consistent as possible across the plural levels, the values tₙ, dₙ and pₙ increase as the value of n increases. Various optimization techniques may be used to determine the values tₙ, dₙ and pₙ, such as empirical methods and/or formulas, theoretical methods and/or formulas, or the like. In one embodiment, pₙ tₙ 2ⁿ⁻¹t.

Additionally, the diameter of the channels 206ₙ, 206ₙ₊₁. . . 206ₙ₊ₓ may generally be selected as to optimize and the airflow velocities. In one embodiment, the diameter of the channels 206 on the nth level are approximately equivalent to the diameter dₙ of holes 202 and 204 on the same level. However, it is understood that the diameter of the channels 206 may be selected based on factors including, but not limited to, desired airflow velocity, desired holding capacity, and desired mechanical integrity.

In general, it is desirable to minimize the size of the openings 202ₙ₌₁, and 204ₙ₌₁, in order to prevent detriment to the objects to be handled. Further, as discussed above, the overall thickness of the handler must be sufficient to maintain structural integrity during handling and/or processing. Thus, with the suitable stacked and interconnected levels described, for example, with respect to FIGS. 2, 3A and 3B, one can use a very small openings 202ₙ₌₁, and 204ₙ₌₁, relative to the overall thickness of the handler. The ratio of overall thickness to the diameter of the surface openings 202ₙ₌₁ and 204ₙ₌₁,

$$\frac{{\sum }_{n = 1}^{n = y} {t}_{n}}{{d}_{n = 1}} ,$$

is generally about 10⁷-10², preferably 10⁶-10³, and more preferably 10⁵-10⁴.

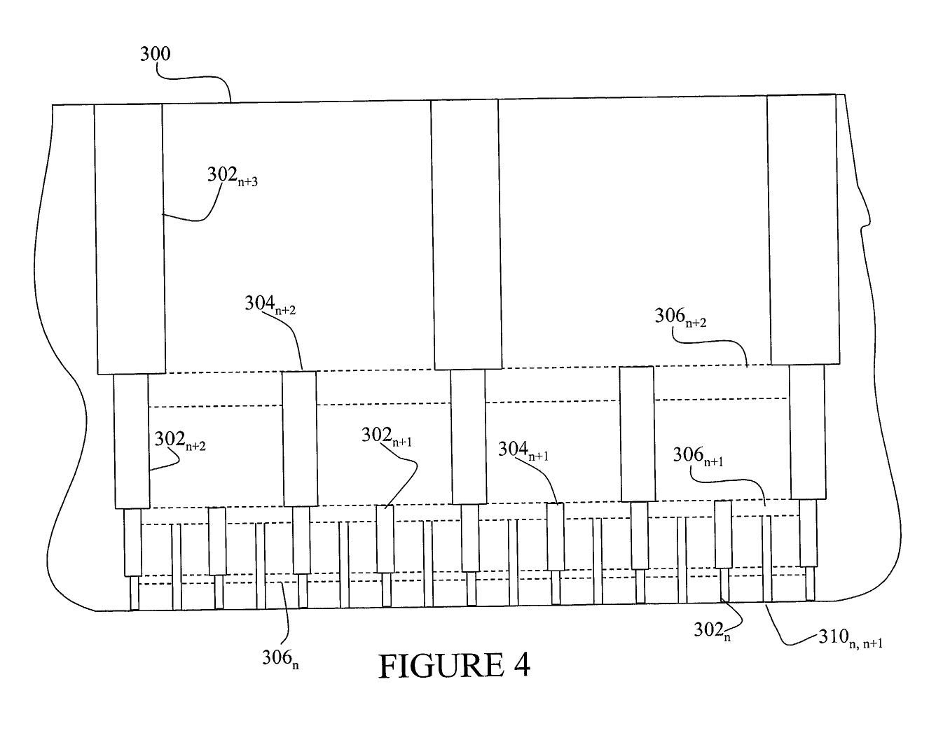

Referring now to FIG. 4, another embodiment of a handler is depicted. A handler 300 is generally similar to handler 200 described above, with the exception that alternating holes 310_{n, n+1}, on the first level (n) extend to the second level (n+1). The openings aligned with openings thereabove are referenced as openings 302ₙ, 302ₙ₊₁, 302ₙ₊₂ and 302ₙ₊₃. The openings not aligned with openings thereabove and not extending beyond the given level are referenced as openings 304ₙ₊₁, 304ₙ₊₂. Horizontal channels 306ₙ, 306ₙ₊₁, and 306ₙ₊₂, are also provided, generally wherein the channels 306ₙ and 306ₙ₊₁ are in fluid communication with holes 310_{n, n+1}.

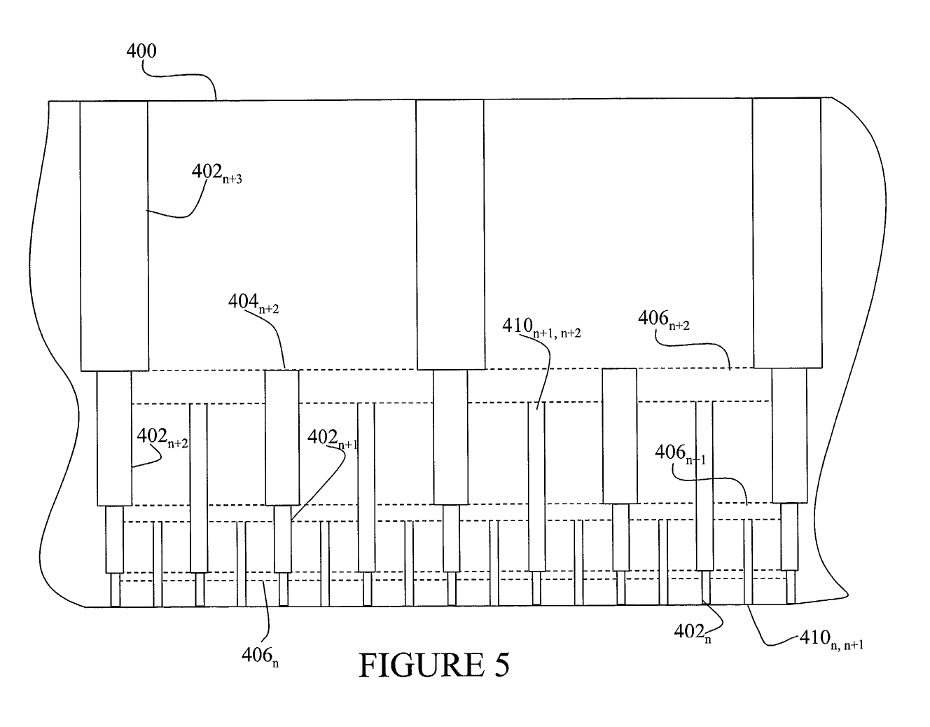

Referring now to FIG. 5, another embodiment of a handler is depicted. A handler 400 is generally similar to handler 200 described above, with the exception that alternating holes 410_{n, n+1} on the first level (n) extend to the second level (n+1), and holes 410_{n+1, n+2} on the second level (n+1) extend to the third level (n+2). The openings aligned with openings thereabove are referenced as openings 402ₙ, 402ₙ₊₁, 402ₙ₊₂ and 402ₙ₊₃. The openings not aligned with openings thereabove and not extending beyond the given level are referenced as openings 404ₙ₊₂. Horizontal channels 406ₙ, 406ₙ₊₁ and 406ₙ₊₂. are also provided, generally wherein the channels 406ₙ and 406ₙ₊₁ are in fluid communication with holes 410_{n, n+1}, and the channels 406ₙ₊₁ and 406ₙ₊₂ are in fluid communication with holes 410_{n+1, n+2}.

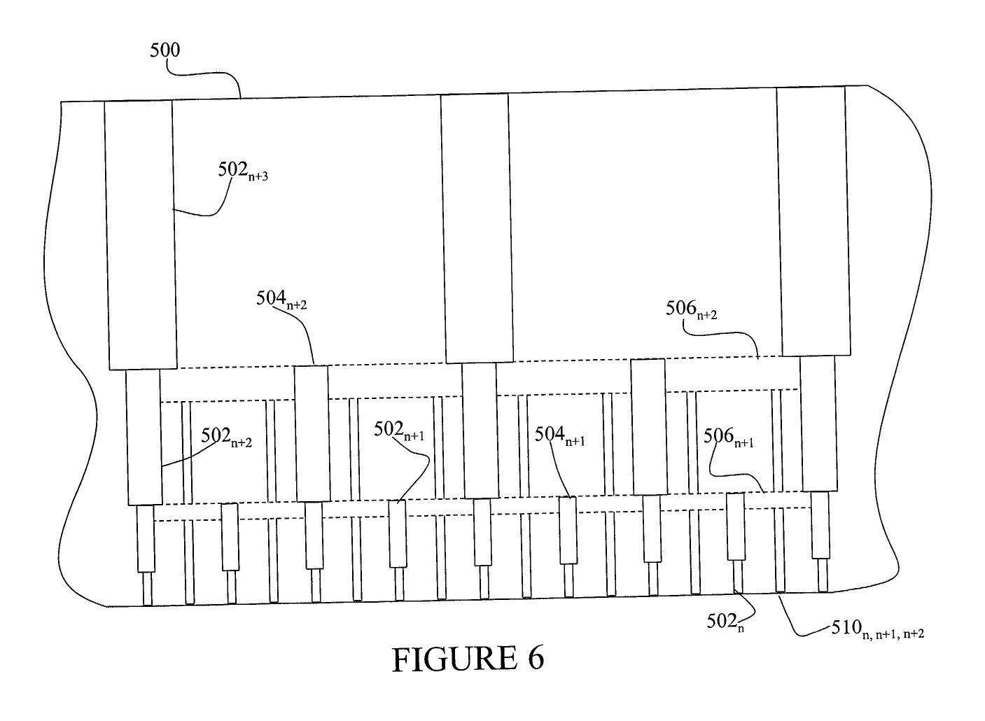

Referring now to FIG. 6, another embodiment of a handler is depicted. A handler 500 is generally similar to handler 200 described above, with the exception that alternating holes 510_{n, n+1, n+2} on the first level (n) extend to the second level (n+1) and the third level (n+2). The openings aligned with openings thereabove are referenced as openings 502ₙ, 502ₙ₊₁, 502ₙ₊₂ and 502ₙ₊₃. The openings not aligned with openings thereabove and not extending beyond the given level are referenced as openings 504ₙ₊₁, and 504ₙ₊₂. Horizontal channels 506ₙ₊₁ and 506ₙ₊₂. are also provided, generally wherein the channels 506ₙ₊₁ and 506ₙ₊₂ are in fluid communication with holes 510_{n, n+1, n+2}.

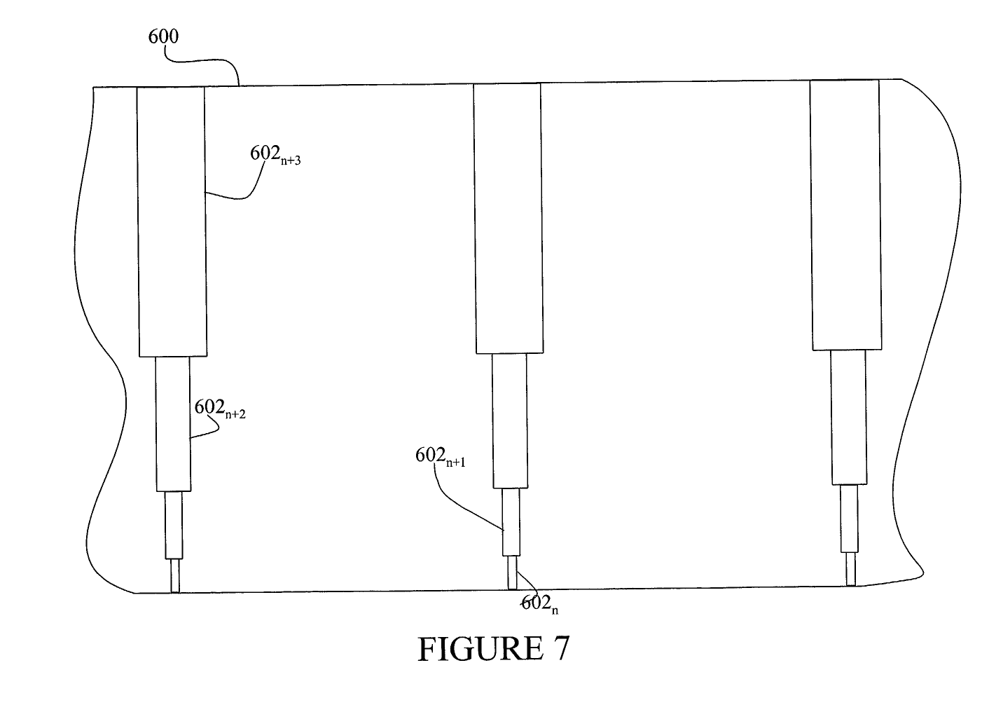

Referring now to FIG. 7, an embodiment of a handler without horizontal interconnecting channels is depicted. A handler 600 includes a series of stacked holes 602ₙ, 602ₙ₊₁, 602ₙ₊₂ and 602ₙ₊₃. Since the frequency of the holes is the same at each level, interconnecting holes are not necessary.

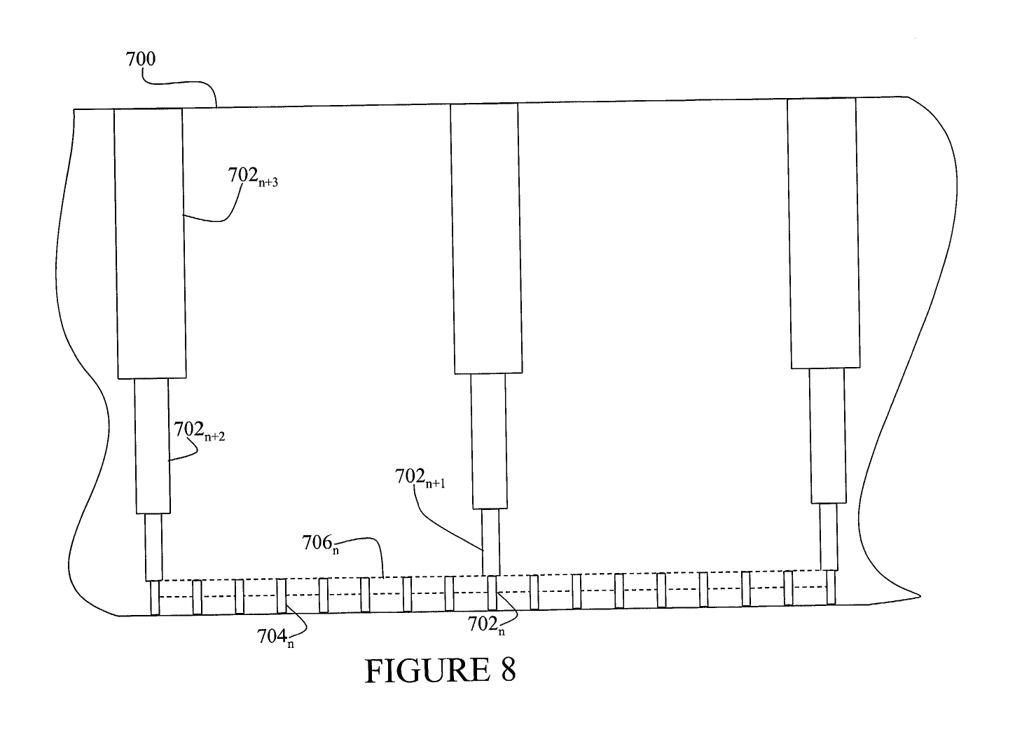

Referring now to FIG. 8, an embodiment of a handler having a larger plurality of holes at the holding surface as compared to the remaining structure is shown. A handler 700 includes a series of stacked holes 702ₙ, 702ₙ₊₁, 702ₙ₊₂ and 702ₙ₊₃. Further, a plurality of holes 704ₙ are provided at the first level, where the object to be held is intended to be situated. The plurality of holes 704ₙ are in fluid communication with the series of stacked holes 702ₙ, 702ₙ₊₁, 702ₙ₊₂ and 702ₙ₊₃ with a channel 706ₙ. To compensate for the much larger ratio of holes 704ₙ compared to the number of holes on levels n+1, N=2 and n+3, the diameter of the channel 706ₙ may, in some embodiments, be larger than the diameter of the hole 704ₙ. Further, the position of the channel 706ₙ may, in some embodiments, be in between levels n and n+1.

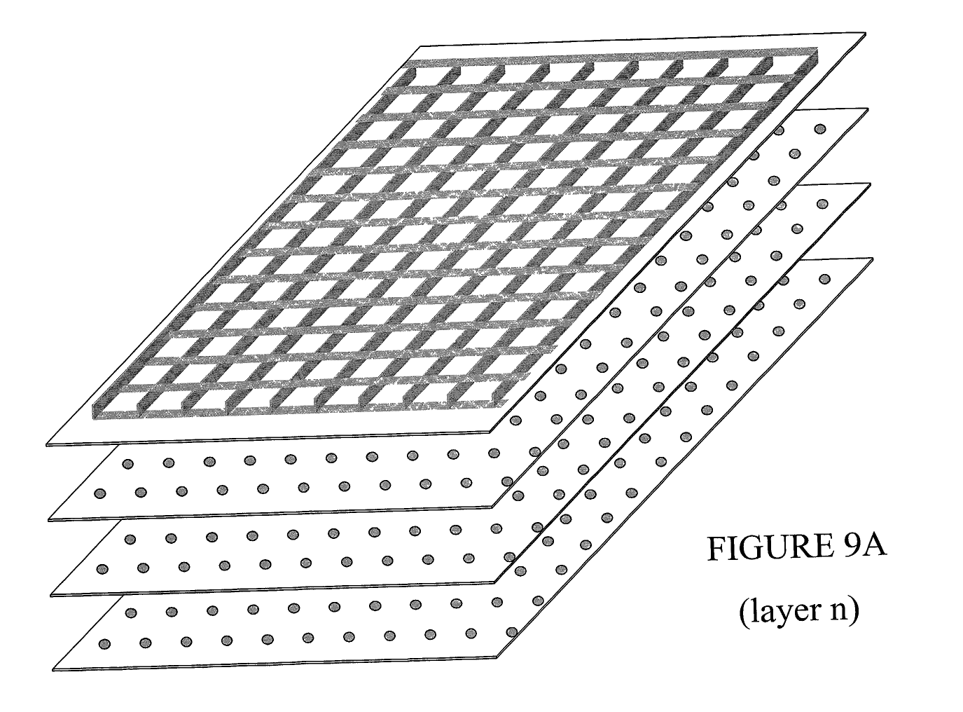

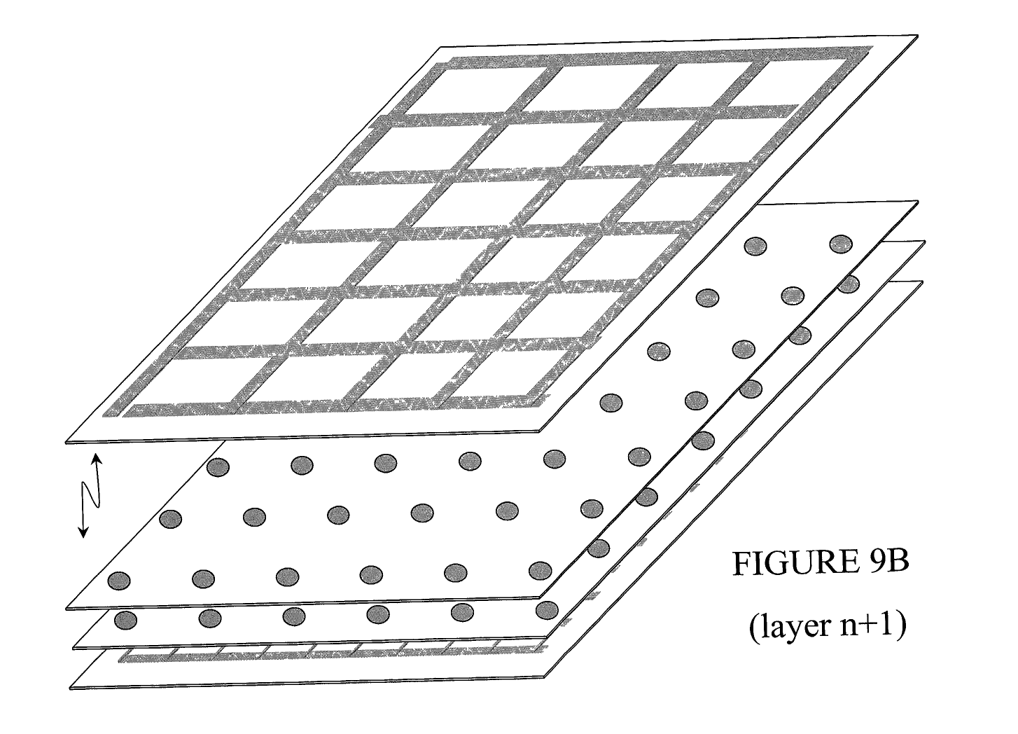

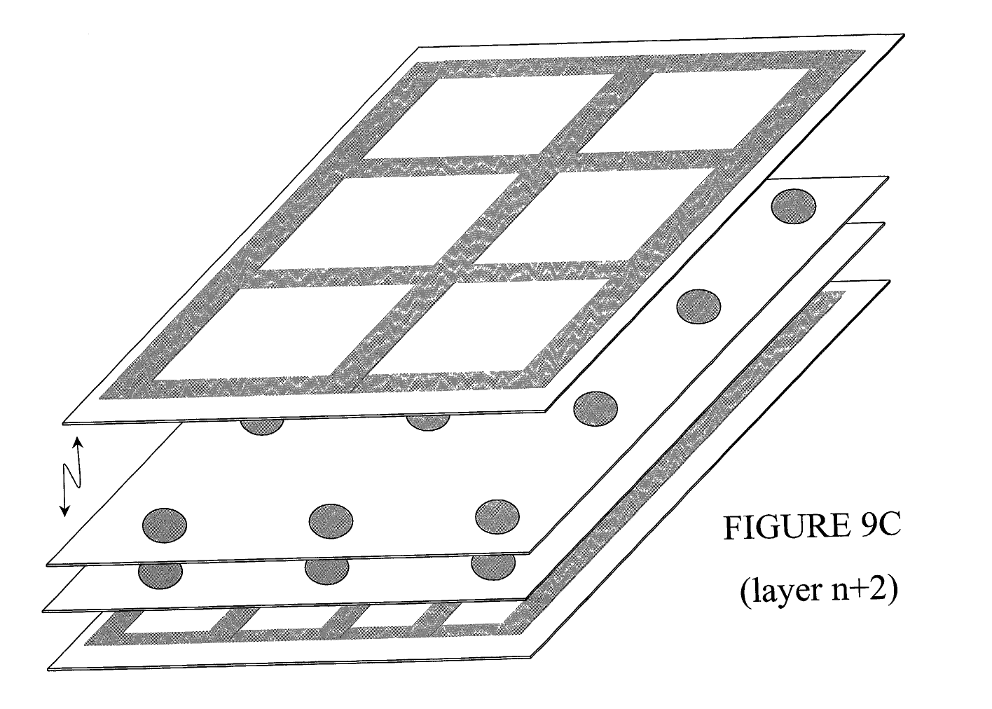

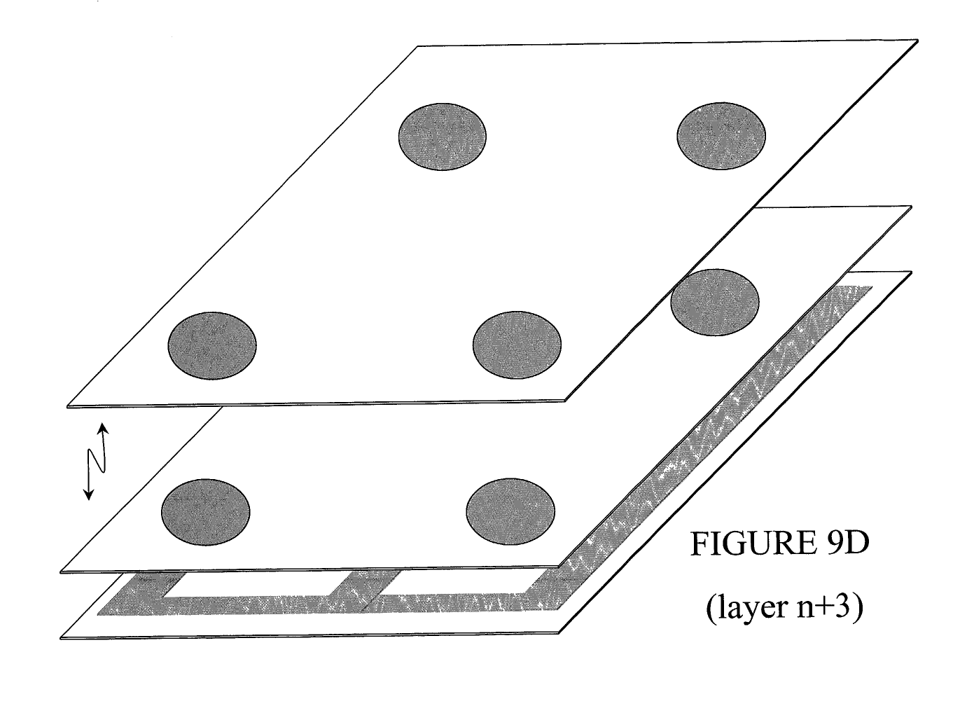

The handlers described above may be constructed by a variety of methods. For example, in certain embodiments, all or a portion of the openings or channels may be micro-machined. In other embodiments, and referring now to FIGS. 9A-9D, a plurality of patterned layers may be aligned, stacked and bonded. The layers are patterned such that upon stacking, the holes and channels (e.g., as shown in various embodiments in FIGS. 2-8) are defined. Note that the layers may be derived from various sources, including, but not limited to, grown layers, etched layers, micro-machined layers, or the like. In one embodiment, thin films for the layers may be derived as described in U.S. patent application Ser. No. 09/950,909 entitled “Thin Films and Production Methods Thereof” filed on Sep. 12, 2001 by Sadeg M. Faris, and incorporated by reference herein. In general, a method to form a layered structure generally comprises selectively adhering a first substrate to a second substrate, wherein, and processing at least a portion of a pattern or other useful structure in or upon the first layer, at the regions where the adhesion between the layers is relatively weak. In the instant application, the first substrate may comprise a layer intended to be patterned, and the patterned layer may subsequently be debonded from the second support layer.

The bonding of the patterned layers may be accomplished by a variety of techniques and/or physical phenomenon, including but not limited to, eutectic, fusion, anodic, vacuum, Van der Waals, chemical adhesion, hydrophobic phenomenon, hydrophilic phenomenon, hydrogen bonding, coulombic forces, capillary forces, very short-ranged forces, or a combination comprising at least one of the foregoing bonding techniques and/or physical phenomenon.

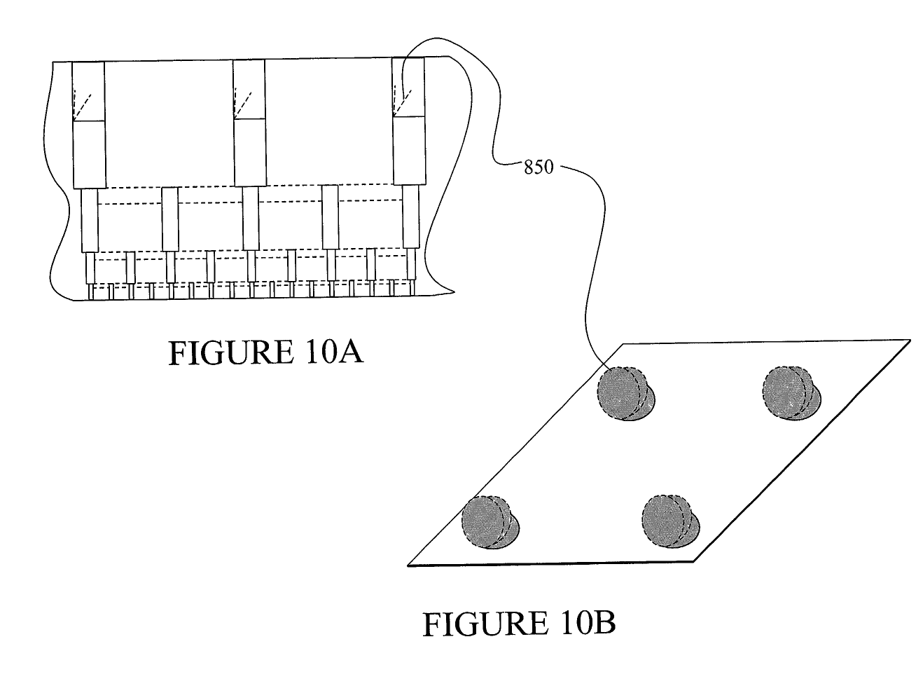

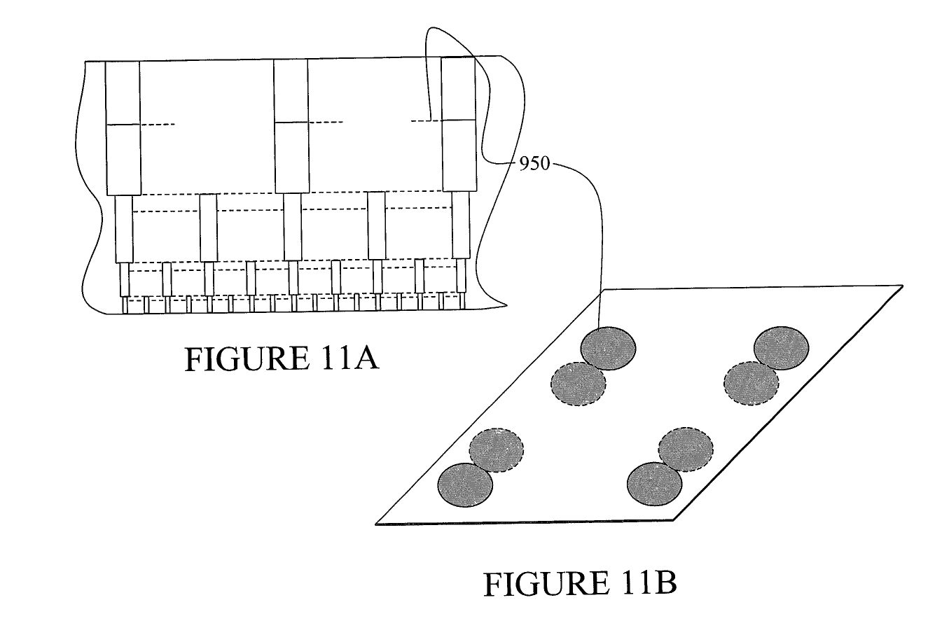

One or more of the openings within the handler may be provided with valves to control provision of the suction force. These valves may be used, for example, to facilitate transport of the handle and the attracted object (e.g., as described above with respect to FIG. 1B). Also, these valves may be used to controllably attach objects having irregular shapes or particular patterns or structures thereon, such as delicate regions that may not be subjected to the same suction force as the remainder of the object. One example of micro-valves in a handler is depicted in FIGS. 10A and 10B, wherein a plurality of micro-valves 850 capable of hingedly lifting are provided in the openings at the suction surface level. Another example of micro-valves in a handler is depicted in FIGS. 11A and 11B, wherein a plurality of micro-valves 850 capable of slidably moving are provided in the openings at the suction surface level. However, similar micro-valves may be provided in the interconnecting channels or openings in lower levels, as required by the application. The micro-valves may be controlled by on-board (e.g., embedded within the handler) electronic control, or external electronic control.

In one example, the above referenced U.S. patent application Ser. No. 09/950,909 entitled “Thin Films and Production Methods Thereof”, incorporated by reference herein, may be used to fabricate the layers, particularly the levels including the micro-valves. Further, the fabrication techniques described therein facilitate integration of micro-valves with microelectronics, enabling inclusion of micro-electro-mechanical structures therein.

The material of construction for the handler may be any suitable material having the requisite structural integrity and chemical inertness. For example, various metals, alloys, semiconductor materials, ceramics, combinations comprising at least one of the foregoing, and others that would be easily recognized by one skilled in the art. If a handler is intended for use in further semiconductor processing, semiconductor materials may be desired, including but not limited to, silicon, III-V type semiconductors, II-IV type semiconductors, II-VI type semiconductors, IV-VI type semiconductors, Ge, C, Si-oxide, Si-nitride, combinations comprising at least one of the foregoing semiconductors, and others that would be easily recognized by one skilled in the art.

In operation, the various embodiments of handlers described herein have the capability to serve as a temporary substrate during processing of, for example, thin films. When the handler is formed of materials compatible with the intended processes (e.g., similar to the materials being processed), it may be subjected to the processing conditions, which in many circumstances is very harsh. After processing of the object, it is disconnected, and the handler may be reused for processing another object. Note that the handler described herein generally possesses the balance of the requisite mechanical integrity, desirably small holes at the holding surface, and sufficiently low vacuum path resistance to allow such operations, namely, attaching an object such as a thin film to the handler, processing the object utilizing the handler as a substrate, quickly releasing the object after processing, and reusing the handler for further operations.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A handler for applying a vacuum holding force to an object, the handler comprising:
a body having a plurality of levels of openings including a holding surface level and a suction surface level, wherein the openings at the suction surface level are larger than the openings at the holding surface level, and further wherein the openings at the suction surface level are in fluid communication with at least a portion of the openings at the holding surface level.

2. The handler as in claim 1, wherein the frequency of the openings at the holding surface level is greater than the frequency of the openings at the suction surface level.

3. The handler as in claim 2, wherein at least a portion of the openings at the suction surface level that are in fluid communication with at least a portion of the openings at the holding surface level are in direct fluid communication by alignment of the openings,
further comprising interconnecting openings for interconnecting openings at the holding surface level that are not in direct fluid communication by alignment of the openings.

4. The handler as in claim 2, further comprising at least one intermediate level between the holding surface level and the suction surface level, wherein the openings of the intermediate level are larger than the openings at the holding surface level and smaller that the openings at the suction surface level.

5. The handler as in claim 4, wherein the frequency of the openings at the intermediate level is greater than the frequency of the openings at the suction surface level.

6. The handler as in claim 5, wherein at least a portion of the openings at the suction surface level that are in fluid communication with at least a portion of the openings at the intermediate level are in direct fluid communication by alignment of the openings, and at least a portion of the openings at the intermediate level that are in fluid communication with at least a portion of the openings at the holding surface level are in direct fluid communication by alignment of the openings,
further comprising interconnecting openings for interconnecting openings at the intermediate level and at the holding surface level that are not in direct fluid communication by alignment of the openings.

7. The handler as in claim 1, further comprising at least one micro-mechanical valve in at least one of the openings.

8. The handler as in claim 1 formed of a material selected from the group consisting of metals, alloys, semiconductor materials, ceramics, and combinations comprising at least one of the foregoing materials.

9. The handler as in claim 1 formed of a semiconductor material selected from the group consisting of silicon, III-V type semiconductors, II-IV type semiconductors, II-VI type semiconductors, IV-VI type semiconductors, Ge, C, Si-oxide, Si-nitride, and combinations comprising at least one of the foregoing semiconductor materials.

10. A method of making the handler as in claim 1, comprising micro-machining the openings at each level.

11. A method of making the handler as in claim 3, comprising micro-machining the openings at each level.

12. A method of making the handler as in claim 1, comprising stacking patterned layers to form the openings at each level.

13. The method as in claim 12, wherein each patterned layer is provided by selectively adhering a layer to be patterned to a support layer, patterning the patterned layer, and removing the patterned layer from the support layer.

14. A method of making the handler as in claim 3, comprising stacking patterned layers to form the openings at each level.

15. The method as in claim 14, wherein each patterned layer is provided by selectively adhering a layer to be patterned to a support layer, patterning the patterned layer, and removing the patterned layer from the support layer.

16. A handler for applying a vacuum holding force to an object comprises:
a handler body having a thickness, a holding surface having a plurality of holes for imparting vacuum force to an object, and a vacuum surface having at least one hole for a vacuum source, the holding surface holes having diameters suitable for holding fragile objects utilizing a vacuum holding force, wherein vacuum paths are formed from the plurality of holding surface holes to the at least one vacuum surface hole, the vacuum paths configured, positioned and dimensioned to reduce resistance of gas flowing through the vacuum paths.

17. The handler as in claim 16, wherein the ratio of the handler body thickness to holding surface hole diameter is about 10⁷ to about 10².

18. The handler as in claim 16, wherein the ratio of the handler body thickness to holding surface hole diameter is about 10⁶ to about 10³.

19. The handler as in claim 16, wherein the ratio of the handler body thickness to holding surface hole diameter is about 10⁵ to about 10⁴.

20. A method of processing a thin film comprising:
providing a first thin film to be processed;
attaching the first thin film to the handler of claim 16, and
processing the first thin film utilizing the handler as a temporary substrate.

21. The method as in claim 20, further comprising disconnecting the thin film from the handler.

22. The method as in claim 21, further comprising providing a second thin film to be processed, attaching the second thin film to the handler, and processing the second thin film utilizing the handler as a temporary substrate.
